(19) United States
(12) Patent Application Publication
(10) Pub. No.: US 2025/0331571 A1
(43) Pub. Date: Oct. 30, 2025

(54) AEROSOL PROVISION DEVICE OR VAPOUR PROVISION DEVICE

(71) Applicant: NICOVENTURES TRADING LIMITED, London (GB)

(72) Inventor: Robert GRUAR, London (GB)

(21) Appl. No.: 18/858,069

(22) PCT Filed: Apr. 20, 2023
(86) PCT No.: PCT/EP2023/060356

§ 371 Date: Oct. 18, 2024

(30) Foreign Application Priority Data
Apr. 22, 2022 (GB) 2205932.3

(51) Int. Cl. A24F 40/50; A24F 40/90; H01G 11/04; H01G 11/22

(52) U.S. Cl. CPC A24F 40/50; A24F 40/90; H01G 11/04; H01G 11/22

(57) ABSTRACT

An aerosol provision device or a vapor provision device including an aerosol generator or vapor generator; a driving circuit connected to the aerosol generator or vapor generator, wherein the driving circuit is configured to employ either pulse width modulation or amplitude modulation, to supply power to the aerosol generator or vapor generator; and a power source connected to the driving circuit, wherein the power source includes a hybrid ion capacitor.

### RELATED APPLICATIONS

The present application is a National Phase entry of PCT Application No. PCT/EP2023/060356 filed Apr. 20, 2023, which claims priority to GB Application No. 2205932.3 filed Apr. 22, 2022, each of which is hereby incorporated by reference in their entirety.

### TECHNICAL FIELD

The present invention relates to an aerosol provision device or a vapor provision device, an aerosol provision system or a vapor provision system, a method of generating an aerosol and a method of generating a vapor.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium.

It is also known to use a resistive heater to heat an aerosol generating article.

Aerosol provision devices are known which comprise a cylindrical heating chamber into which a rod shaped aerosol generating article is inserted. Conventional aerosol provision devices are typically powered by a rechargeable lithium ion battery (“LiB”).

One problem with using a lithium ion battery as a power source is that lithium ion batteries can take a relatively long time to charge. For example, a conventional aerosol provision device powered by a lithium ion battery may take approx. 7-10 mins to charge. Furthermore, the performance of a lithium ion battery may degrade with time after the lithium ion battery has been recharged a certain number of times. As a result, conventional aerosol provision devices may be limited to being recharged, for example, a maximum of 2000-3000 times which limits the lifetime of the device.

Another issue with conventional aerosol provision devices powered by a lithium ion battery is that there are environmental and safety issues with regards the use of lithium ion batteries.

It is desired to provide an improved aerosol provision device or vapor provision device.

### SUMMARY

According to an aspect there is provided an aerosol provision device or a vapor provision device comprising:
an aerosol generator or vapor generator;
a driving circuit connected to the aerosol generator or vapor generator, wherein the driving circuit is configured to employ either pulse width modulation or amplitude modulation to supply power to the aerosol generator or vapor generator; and
a power source connected to the driving circuit, wherein the power source comprises a hybrid ion capacitor.

An aerosol provision device or vapor provision device according to various embodiments comprises a power source comprising a hybrid ion capacitor (“HIC”) in contrast to conventional devices which are typically powered by a lithium ion battery (“LiB”). The hybrid ion capacitor may comprise a lithium ion capacitor (“LIC”) or a sodium ion capacitor (“SIC”).

An aerosol provision device or a vapor provision device powered by a hybrid ion capacitor (“HIC”) according to various embodiments has a number of benefits compared with conventional devices powered by a lithium ion battery (“LiB”). One benefit is that the time taken to recharge the power source is significantly reduced from around typically 7-10 mins in the case of a conventional aerosol provision device powered by a lithium ion battery (“LiB”) to around 20-30 s according to various embodiments. It will be appreciated that this represents a significant reduction in time. It will also be understood that a recharge time of 20-30 s is sufficient to re-charge an aerosol provision device, for example, such that the aerosol provision device has sufficient charge to power at least one full session of use lasting, for example, at least 3 minutes and involving at least 10 puffs.

Another benefit is that a power source comprising a hybrid ion capacitor may be recharged a significantly greater number of times compared with a conventional lithium ion battery. As a result, an aerosol provision device or vapor provision device according to various embodiments has a significantly greater longevity compared with conventional devices powered by a lithium ion battery.

According to various arrangements the hybrid ion capacitor may be recharged approx. 50000-100000 times during the lifetime of the device and an aerosol provision device according to various embodiments may therefore be capable of performing approx. 100000 sessions. It will be understood that the ability to perform approx. 100000 sessions represents a significantly greater number of sessions than might be expected from a conventional aerosol provision device powered by a lithium ion battery wherein the lithium ion battery may typically be recharged a maximum of approx. 3000 times. If each charge is sufficient to support, for example, 3 sessions of use then a conventional aerosol provision device may be capable of only supporting a maximum of approx. 9000 sessions during the lifetime of the device.

It will be understood, therefore, that an aerosol provision device according to various embodiments which incorporates a hybrid ion capacitor as a power source may be capable of performing an order of magnitude greater number of sessions during the expected lifetime of the aerosol provision device compared with a conventional aerosol provision device powered by a lithium ion battery.

A further benefit of using a hybrid ion capacitor as the power source is that hybrid ion capacitors have improved environmental and safety characteriztics compared with lithium ion batteries. For example, it is known that with lithium ion batteries that when a short circuit occurs, the temperature of the cell may be raised by the short circuit current. This may result in thermal runaway of the cell and energetic disassembly involving a risk of fire and/or explosion. However, by contrast, lithium ion capacitors do not present either a fire or an explosion risk.

Optionally, the driving circuit is configured to employ high frequency pulse width modulation to supply power to the aerosol generator or vapor generator.

It will be understood that pulse width modulation (“PWM”) relates to the application of a square wave which is switched between an ON and OFF state and wherein the duty cycle and the frequency of the signal determine the effect of the signal. The duty cycle of a pulse width modulated signal relates to the ratio of the time that the signal is ON relative to the total time taken to complete a cycle. It will be understood that a cycle comprises the period of time during which the square wave is ON for one pulse or time period and then is switched OFF for a subsequent time period. The duty cycle is commonly expressed as a percentage or a ratio. For example, a 50% duty cycle corresponds with the signal being ON for 50% of the total time and being OFF for 50% of the time. A 100% duty cycle means that the signal is ON for 100% of the time and a 0% duty cycle means the signal is ON for 0% of the time i.e. that the signal is OFF. The frequency is the number of times a periodic change is completed per unit time and is the inverse of the time period.

It will be understood that in contrast to pulse width modulation (wherein the amplitude of the pulses remain constant), amplitude modulation concerns a process wherein the amplitude of the signal is modulated.

Optionally, the driving circuit is configured to operate at and/or to employ pulse width modulation at a frequency >800 Hz. For example, according to various arrangements the driving circuit may be configured to operate at and/or to employ pulse width modulation at a frequency 800-1000 Hz, 1000-1200 Hz, 1200-1400 Hz, 1400-1600 Hz, 1600-1800 Hz, 1800-2000 Hz or >2000 Hz.

Optionally, the hybrid ion capacitor comprises a lithium ion capacitor (“LIC”).

According to an alternative arrangement, the hybrid ion capacitor may comprise a sodium ion capacitor (“SIC”).

Optionally, the hybrid ion capacitor comprises a battery-like anode and a capacitor-like cathode.

Optionally, the hybrid ion capacitor comprises an anode comprising carbon material pre-doped with lithium ions.

Optionally, the hybrid ion capacitor comprises a cathode comprising a high surface-area electrode.

Optionally, the cathode comprises activated carbon (“AC”) or porous carbon.

Optionally, the hybrid ion capacitor has an energy density of: (i) 10-20 Wh/kg; (ii) 20-30 Wh/kg; (iii) 30-40 Wh/kg; or (iv) 40-50 Wh/kg.

Optionally, the hybrid ion capacitor has a power density of: (i) 1000-2000 W/kg; (ii) 2000-3000 W/kg; (iii) 3000-4000 W/kg; (iv) 4000-5000 W/kg; (v) 5000-6000 W/kg; (vi) 6000-7000 W/kg; (viii) 7000-8000 W/kg; (ix) 8000-9000 W/kg; or (x) 9000-10000 W/kg.

Optionally, the power source is chargeable within <30 s to provide at least 400 J to the aerosol generator or vapor generator for a session of use lasting at least 200 s.

According to an aspect there is provided an aerosol provision system or vapor provision system comprising:
an aerosol provision device or vapor provision device as described above; and
a charging unit.

Optionally, the charging unit is arranged to charge the power source.

The aerosol provision device or vapor provision device may comprise one or more first electrical connectors and the charging unit may comprise one or more second electrical connectors. The aerosol provision device or vapor provision device may be electrically connected to the charging unit via the first and second electrical connectors.

According to an aspect there is provided an aerosol provision system or a vapor provision system comprising:
an aerosol provision device or a vapor provision device as described above; and
an aerosol generating article comprising aerosol generating material.

According to an aspect there is provided a method of generating an aerosol comprising:
inserting an aerosol generating article comprising aerosol generating material into an aerosol provision device, wherein the aerosol provision device comprises an aerosol generator, a driving circuit connected to the aerosol generator, wherein the driving circuit is configured to employ either pulse width modulation or amplitude modulation to supply power to the aerosol generator and a power source connected to the driving circuit, wherein the power source comprises a hybrid ion capacitor; and
energizing the aerosol generator.

According to an aspect there is provided a method of generating a vapor comprising:
inserting a vapor generating article comprising vapor generating material into a vapor provision device, wherein the vapor provision device comprises a vapor generator, a driving circuit connected to the vapor generator, wherein the driving circuit is configured to employ either pulse width modulation or amplitude modulation to supply power to the vapor generator and a power source connected to the driving circuit, wherein the power source comprises a hybrid ion capacitor; and
energizing the vapor generator.

### BRIEF DESCRIPTION OF THE DRAWINGS

Various embodiments will now be described by way of example only and with reference to the accompanying drawings in which:

FIG. 1 shows a perspective view of an aerosol provision device located within a charging unit;

FIG. 2 shows a partial cross-sectional view of an aerosol provision device located within a charging unit;

FIG. 3 shows a cross sectional view of an aerosol provision device comprising a hybrid ion capacitor power source; and

FIG. 4 shows a schematic view of a power source comprising a hybrid ion capacitor.

### DETAILED DESCRIPTION

Aspects and features of certain examples and embodiments are discussed or described herein. Some aspects and features of certain examples and embodiments may be implemented conventionally and these are not discussed or described in detail in the interests of brevity. It will thus be appreciated that aspects and features of apparatus and methods discussed herein which are not described in detail may be implemented in accordance with conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise a binder and an aerosol former.

Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise one or more active substances and/or flavors, one or more aerosol-former materials, and optionally one or more other functional material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). In some implementations, the non-combustible aerosol provision device may also comprise an aerosol generating component. However, in other implementations the aerosol generating article may comprise partially, or entirely, the aerosol generating component.

For completeness, aerosol provision devices comprising an inductive element are known. The aerosol provision device may comprise one or more inductors and a susceptor which is arranged to be heated by the one or more inductors.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

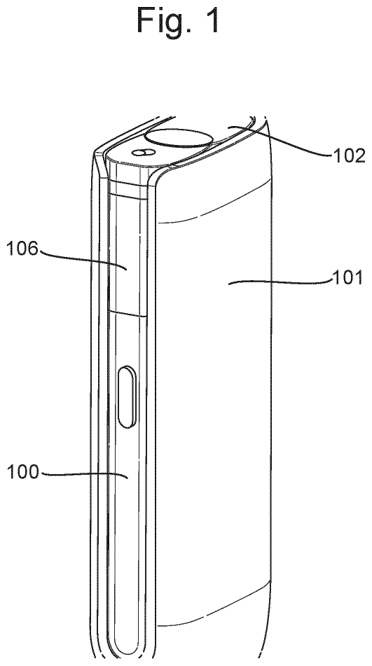

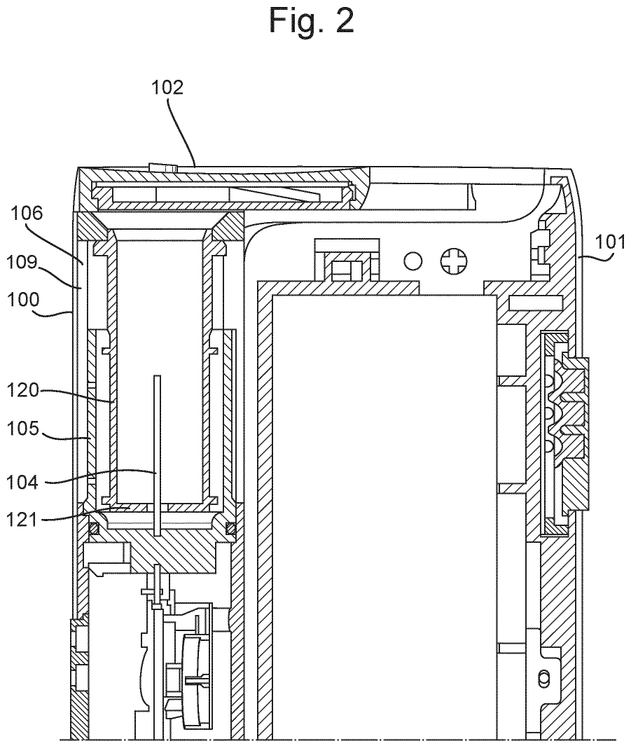

According to various arrangements an aerosol provision device or a vapor provision device is provided which may be arranged to be charged by a charging unit. In particular, an aerosol provision device in combination with a charging unit is described below with reference to FIGS. 1-2. However, it is not essential that a charging unit is provided and hence the interaction of an aerosol provision device as described below with a charging unit is for illustrative purposes.

Furthermore, although an aerosol provision device is described in further detail below, it should also be understood that according to various embodiments a vapor provision device incorporating a hybrid ion capacitor as a power source may also be provided. The vapor provision device may comprise a heater assembly for heating a liquid to form a vapor.

FIG. 1 shows an aerosol provision device 100 according to an arrangement and is shown located within an elongate cavity of a charging unit 101. The charging unit 101 may comprise a power source (not shown). The power source of the charging unit 101 may include, for example, a battery (single-use or rechargeable), a rechargeable super capacitor, a rechargeable solid-state battery (SSB), a rechargeable lithium-ion battery (LiB) or the like, a hermetically sealed battery, a pouch cell battery or some combination thereof. Whilst the aerosol provision device 100 is shown in combination with a charging unit 101, it will be appreciated that the aerosol provision device 100 may be recharged by other means. For example, a power source provided with the aerosol provision device 100 may be charged by plugging a power supply into the aerosol provision device 100.

According to other embodiments a vapor provision device comprising a power source may be provided. The vapor provision device may comprise a power source which may be arranged to be re-charged by a charging unit.

The aerosol provision device 100 may be left in the charging unit 101 for a predetermined time in order to allow sufficient charging of the aerosol provision device 100. The charging unit 101 may be arranged to charge the aerosol provision device 100 to full charge in a time of <30 s. It will be understood that it may take approx. 7-10 mins to charge a conventional aerosol provision device 100 comprising a lithium ion battery as a power source such that the aerosol provision device 100 is then able to perform e.g. three sessions of use lasting at least 200 s wherein an energy of at least 400 J is supplied by the lithium ion battery to an aerosol generator of the aerosol provision device during each session of use (which typically may involve at least 10 puffs).

The charging unit 101 and/or the aerosol provision device 100 (or alternatively a vapor provision device) may optionally have an indicator to give a visual or other representation to the user of the charging level of the aerosol provision device 100 (or vapor provision device). Additionally, there may be a separate indicator to give a visual representation of the charge level of the charging unit 101. The current charge level of the aerosol provision device 100 (or vapor provision device) and/or the charging unit 101 may be determined by a control device disposed in the aerosol provision device 100 (or vapor provision device) and/or the charging unit 101.

The visual indicator may comprise one or more light-emitting diodes (LEDs). However, it is also contemplated that the visual indicator may be replaced by an audio indicator (e.g. a speaker) or a haptic indicator.

The aerosol provision device 100 (or vapor provision device) may comprise an outer housing which may have a tubular and/or cylindrical shape. However, other arrangements are envisaged wherein the aerosol provision device 100 (or vapor provison device) may take other desired forms e.g. boxed shaped. According to an arrangement the outer housing may comprise an electrical insulator and may, for example, be formed of polyetheretherketone (“PEEK”).

The aerosol provision device 100 (or vapor provision device) may be inserted into the cavity of the charging unit 101 in order to recharge the aerosol provision device 100 (or vapor provision device) by receiving electrical power from the charging unit 101. The charging unit 101 may comprise an internal battery to provide electrical power to the aerosol provision device 100 (or vapor provision device). The charging unit 101 may also be connected to an external source of electrical power.

The charging unit 101 may comprise a lid or cover 102 which may be slid by a user between an open and closed position. The lid or cover 102 may be provided at the entrance to the cavity which is provided within the charging unit 101 and which is configured to receive the aerosol provision device 100 (or vapor provision device).

The aerosol provision device 100 includes an aerosol generator for generating aerosol from aerosol generating material. According to an arrangement the aerosol generator comprises a heating element which may comprise a blade like resistive heating element. An electrical current may be passed through the resistive heating element causing it to become hot and to heat an aerosol generating article which may be inserted on to the heating element.

Other arrangements are also contemplated. For example, it is also contemplated that the aerosol provision device 100 may alternatively comprise an inductive heater for heating an aerosol generating article. According to an arrangement the aerosol provision device 100 may comprise one or more inductors and one or more heating elements which are heatable by penetration with a varying magnetic field. The one or more heating elements may comprise one or more susceptors.

When the lid or cover 102 is in an open position an opening to the cavity may be exposed thereby enabling a user to either remove the aerosol provision device 100 (or vapor provision device) from the charging unit 101 (in order to use the aerosol provision device 100 or vapor provision device) or alternatively to insert the aerosol provision device 100 (or vapor provision device) into the charging unit 101 (in order to charge the aerosol provision device 100 or vapor provision device).

FIG. 2 shows a cross-sectional view showing an aerosol provision device 100 located or docked within a charging unit 101 according to an arrangement. The aerosol provision device 100 comprises a main housing 105 wherein a heating element 104 projects within the main housing 105. The aerosol provision device 100 may further comprise a removable cap 106 which may be magnetically attached to the main housing 105.

As shown in FIG. 2, the removable cap 106 may be attached to a receptacle 120 for receiving an aerosol generating article. In use, an aerosol generating article is inserted in the receptacle 120 and may be slid onto the heating element 104 which may comprise a blade like resistive heating element 104. The removable cap 106 may also include a second outer casing 109. The second outer casing 109 may be arranged to fit at least partially over the main housing 105. In use, the main housing 105 may be partly received between the second outer casing and the receptacle 120. The receptacle 120 and the second outer casing 109 may comprise a one piece component. Alternatively, the receptacle 120 and the second outer casing 109 may comprise separate components which are permanently joined together by, for example, an adhesive or by welding.

The receptacle 120 may comprise a tubular housing having a base portion 121. The base portion 121 of the receptacle 120 may have an aperture and the heating element 104 may be arranged to project through the aperture.

An aerosol generating article may be inserted into the aerosol provision device 100 by inserting the aerosol generating article through an opening in the removable cap 106 and then inserting the aerosol generating article into the receptacle 120 and onto the heating element 104.

The heating element 104 may have a blade like profile and in use an aerosol generating article may be forced onto the heating element 104 so that the blade like profile of the heating element 104 inserts into a distal end of the aerosol generating article. The heating element 104 may be arranged to internally heat the aerosol generating article.

At the end of a session of use, when an aerosol generating article has been consumed, the removable cap 106 may then be detached from the main housing 105. It will be understood that the process of detaching the removable cap 106 will have the effect that the base portion 121 of the receptacle 120 will contact a bottom face of the aerosol generating article. As the removable cap 106 is withdrawn, then the base portion 121 of the receptacle 120 will contact the distal end of the aerosol generating article and will result in the aerosol generating article being pulled off or otherwise removed from the heating element 104.

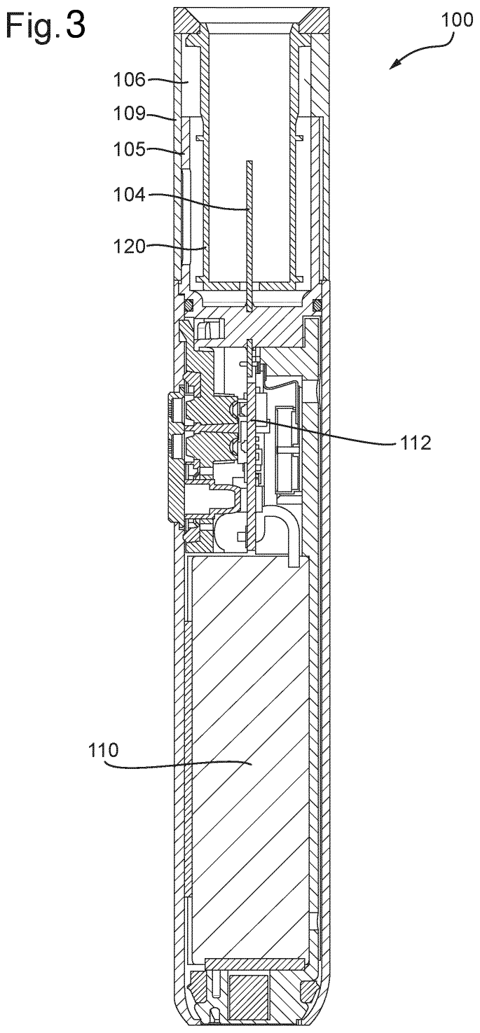

FIG. 3 shows a cross-sectional view of an aerosol provision device 100 according to an arrangement. The aerosol provision device 100 comprises a main housing 105 wherein a heating element 104 is shown extending from the main housing 105. The main housing 105 surrounding the heating element 104 may have a substantially tubular form. The heating element 104 may be arranged to project through an aperture provided in the base portion of the receptacle 120.

The aerosol provision device 100 includes a power source 110 and a driving circuit 112. The driving circuit 112 is connected to the power source 110 and the heating element 104 (or more generally an aerosol generator or vapor generator). The driving circuit 112 is adapted to draw electrical power from the power source 110 and to deliver electrical power to the heating element 104. The driving circuit 112 may be adapted to supply a DC current to the heating element 104. The driving circuit 112 may include a DC-to-DC converter in order to output a DC voltage which is optimized for heating the heating element 104.

The driving circuit 112 may be configured to supply a DC current to the heating element 104 utilizing pulse width modulation in order to supply power to the heating element 104 (or more generally to an aerosol generator). Alternatively, the driving circuit 112 may be configured to employ amplitude modulation in order to supply power to the heating element 104 (or more generally to an aerosol generator).

According to an arrangement the driving circuit 112 may be configured to operate at a frequency of >800 Hz. For example, the driving circuit 112 may be arranged to employ pulse width modulation at a frequency of between 800 Hz and 2000 Hz. According to an arrangement the driving circuit 112 may be configured to operate at a frequency of 800-1000 Hz, 1000-1200 Hz, 1200-1400 Hz, 1400-1600 Hz, 1600-1800 Hz, 1800-2000 Hz or >2000 Hz. It will be understood that the driving circuit 112 operating at a high frequency is intended to mean that the driving circuit 112 either draws power from the power source 110 at that frequency and/or supplies power to the aerosol generator (or vapor generator) at that frequency. The driving circuit 112 may deliver power to the heating element 104 (or aerosol generator or vapor generator) at a first frequency f1 which is different to a second frequency f2 at which it draws power from the power source 110. According to an arrangement the first frequency f1 may be in the range <800 Hz, 800-1000 Hz, 1000-1200 Hz, 1200-1400 Hz, 1400-1600 Hz, 1600-1800 Hz, 1800-2000 Hz or >2000 Hz. According to an arrangement the second frequency f2 may be in the range <800 Hz, 800-1000 Hz, 1000-1200 Hz, 1200-1400 Hz, 1400-1600 Hz, 1600-1800 Hz, 1800-2000 Hz or >2000 Hz.

According to another arrangement the driving circuit 112 may be configured to supply a high frequency alternating current to an inductive heater. For example, according to an arrangement the driving circuit 112 may be arranged to supply an alternating current at frequency of <0.5 MHz, 0.5-1.0 MHz, 1.0-1.5 MHz, 1.5-2.0 MHz, 2.0-2.5 MHz, 2.5-3.0 MHz, 3.0-3.5 MHz, 3.5-4.0 MHz or >4.0 MHz.

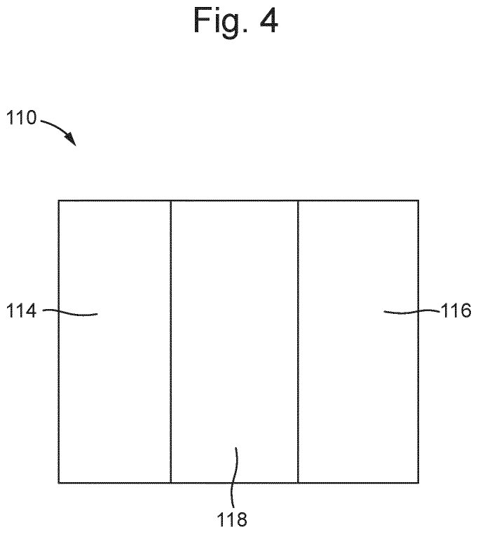

A power source 110 for an aerosol provision device or a vapor provision device according to various embodiments may comprise a hybrid ion capacitor as shown schematically in FIG. 4.

According to an arrangement the hybrid ion capacitor (“HIC”) may comprise a lithium ion capacitor (“LIC”). Alternatively, the hybrid ion capacitor (“HIC”) may comprise a sodium ion capacitor (“SIC”).

A lithium ion capacitor (“LIC”) is a hybrid type of capacitor and may be classified as a type of supercapacitor. It will be understood that hybrid ion capacitors (“HICs”) are so referred because they have an anode which is similar to an anode of a lithium ion battery and a cathode which is similar to a cathode used in a supercapacitor (e.g. high surface area carbon).

It will be understood that lithium ion batteries may be characterized as having a high energy but slow reaction time and are intercalation based. By contrast, supercapacitors may be characterized as having high power, fast reaction times and are capacitance based.

According to various arrangements the hybrid ion capacitor may comprise a battery-like anode 114 and a capacitor-like cathode 116. The anode 114 may comprise carbon material pre-doped with lithium ions. The carbon material may comprise hard carbon, soft carbon or graphene. The anode 114 may comprise lithium titanium oxide. It will be understood that pre-doping with lithium ions is similar to a lithium ion battery anode. The pre-doping lowers the potential of the anode and enables a relatively high output voltage to be achieved.

The cathode 116 may comprise a high surface-area electrode. According to an arrangement the cathode 116 may comprise activated carbon (AC) or porous carbon. According to another arrangement the cathode 116 may comprise graphene.

The anode 114 and the cathode 116 may be separated by an electrolyte 118. The electrolyte 118 may comprise a non-aqueous electrolyte such as an organic electrolyte. Alternatively, the electrolyte 118 may comprise an inorganic electrolyte such as a glass or a ceramic electrolyte. According to an arrangement, the electrolyte 118 may comprise a lithium-ion salt solution.

According to various arrangements a lithium ion capacitor (“LIC”) may be utilized as a power source 110 wherein during a charge-discharge cycle, charge carriers (e.g. lithium ions) are deposited concurrently and asymmetrically by surface ion adsorption/desorption on a capacitor-type electrode (i.e. cathode 116) and Li+ intercalation/de-intercalation on a battery-type electrode (i.e. anode 114). The process may be referred to as a hybrid energy storage process. It will also be understood that intercalation chemistry limits the maximum charge/discharge rate.

Lithium ion capacitors may be categorized as dual-carbon (“DC-LIC”), non-carbon or mixed form dependent upon whether or not the electrodes contain carbon materials. According to various arrangements the power source 110 may comprise either a dual-carbon, a non-carbon or a mixed form lithium ion capacitor.

The hybrid ion capacitor which may be utilized as a power source 110 may have an energy density in the range 10-50 Wh/kg. For example, the hybrid ion capacitor may have an energy density of 10-20 Wh/kg, 20-30 Wh/kg, 30-40 Wh/kg or 40-50 Wh/kg. According to various arrangements the hybrid ion capacitor may have a power density in the range 1000-10000 W/kg. For example, the hybrid ion capacitor may have a power density of 1000-2000 W/kg, 2000-3000 W/kg, 3000-4000 W/kg, 4000-5000 W/kg, 5000-6000 W/kg, 6000-7000 W/kg, 7000-8000 W/kg, 8000-9000 W/kg or 9000-10000 W/kg. The power source 110 may be chargeable within 20 s or 30 s to provide sufficient power to power an aerosol provision device for at least one entire session of use.

As discussed above, according to various embodiments a vapor provision device may be provided comprising a power source 110 comprising a hybrid ion capacitor. According to an arrangement the vapor provision device may be configured to heat a liquid vapor generating medium in order to provide a vapor. The power source may be chargeable within 20 s or 30 s to provide sufficient power to power a vapor provision device for at least 30 puffs.

According to various arrangements a lithium ion capacitor may be utilized as the power source 110 and may have an operating temperature range of −15° C. to +85° C. at 3.5 V and a capacitance range of 10-450 F with a capacitance tolerance of ±20%. The operating temperature range of the lithium ion capacitor may be wider than a conventional LFP battery (i.e. a battery comprising lithium iron phosphate (LiFePO4) as the cathode material alongside a graphite carbon electrode with a metallic backing as the anode).

The rated voltage of the lithium ion capacitor according to various arrangements may be 3.5 or 3.8 V DC with a minimum rated voltage of 2.2 V DC and surge voltage of 4.2 V DC. The lithium ion capacitor may beneficially have a significantly improved lifetime compared to a conventional LFP battery.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device or a vapor provision device comprising:
an aerosol generator or vapor generator;
a driving circuit connected to the aerosol generator or vapor generator, wherein the driving circuit is configured to employ either pulse width modulation or amplitude modulation, to supply power to the aerosol generator or vapor generator; and
a power source connected to the driving circuit, wherein the power source comprises a hybrid ion capacitor.

2. An aerosol provision device or a vapor provision device as claimed in claim 1, wherein the driving circuit is configured to employ high frequency pulse width modulation to supply power to the aerosol generator or vapor generator.

3. An aerosol provision device or a vapor provision device as claimed in claim 1, wherein the driving circuit is configured to operate at and/or employ pulse width modulation at a frequency >800 Hz.

4. An aerosol provision device or a vapor provision device as claimed in claim 1, wherein the hybrid ion capacitor comprises a lithium ion capacitor (“LIC”).

5. An aerosol provision device or a vapor provision device as claimed in claim 1, wherein the hybrid ion capacitor comprises a sodium ion capacitor (“SIC”).

6. An aerosol provision device or a vapor provision device as claimed in claim 1, wherein the hybrid ion capacitor comprises a battery-like anode and a capacitor-like cathode.

7. An aerosol provision device or a vapor provision device as claimed in claim 1, wherein the hybrid ion capacitor comprises an anode comprising carbon material pre-doped with lithium ions.

8. An aerosol provision device or a vapor provision device as claimed in claim 1, wherein the hybrid ion capacitor comprises a cathode comprising a high surface-area electrode.

9. An aerosol provision device or a vapor provision device as claimed in claim 8, wherein the cathode comprises activated carbon (“AC”) or porous carbon.

10. An aerosol provision device or a vapor provision device as claimed in claim 1, wherein the hybrid ion capacitor has an energy density of: (i) 10-20 Wh/kg; (ii) 20-30 Wh/kg; (iii) 30-40 Wh/kg; or (iv) 40-50 Wh/kg.

11. An aerosol provision device or a vapor provision device as claimed in claim 1, wherein the hybrid ion capacitor has a power density of: (i) 1000-2000 W/kg; (ii) 2000-3000 W/kg; (iii) 3000-4000 W/kg; (iv) 4000-5000 W/kg; (v) 5000-6000 W/kg; (vi) 6000-7000 W/kg; (viii) 7000-8000 W/kg; (ix) 8000-9000 W/kg; or (x) 9000-10000 W/kg.

12. An aerosol provision device or a vapor provision device as claimed in claim 1, wherein the power source is chargeable within <30 s to provide at least 400 J to the aerosol or vapor generator for a session of use lasting at least 200 s.

13. An aerosol provision system or a vapor provision system comprising:
an aerosol provision device or a vapor provision device as claimed in claim 1; and
a charging unit.

14. An aerosol provision system or a vapor provision system as claimed in claim 13, wherein the charging unit is arranged to charge the power source.

15. An aerosol provision system or a vapor provision system comprising:
an aerosol provision device or a vapor provision device as claimed in claim 1; and
an aerosol generating article comprising aerosol generating material.

16. A method of generating an aerosol comprising:
inserting an aerosol generating article comprising aerosol generating material into an aerosol provision device, wherein the aerosol provision device comprises an aerosol generator, a driving circuit connected to the aerosol generator, wherein the driving circuit is configured to employ either pulse width modulation or amplitude modulation to supply power to the aerosol generator and a power source connected to the driving circuit, wherein the power source comprises a hybrid ion capacitor; and
energizing the aerosol generator.

17. A method of generating a vapor comprising:
inserting a vapor generating article comprising vapor generating material into a vapor provision device, wherein the vapor provision device comprises a vapor generator, a driving circuit connected to the vapor generator, wherein the driving circuit is configured to employ either pulse width modulation or amplitude modulation to supply power to the vapor generator and a power source connected to the driving circuit, wherein the power source comprises a hybrid ion capacitor; and
energizing the vapor generator.
